(19) United States
(12) Patent Application Publication
(10) Pub. No.: US 2025/0083884 A1
(43) Pub. Date: Mar. 13, 2025

(54) PACKAGING FOR A MARKETABLE PRODUCT IN A MARKETABLE CONFIGURATION

(71) Applicant: MAS Marketing Holding Company, LLC, Gainesville, GA (US)

(72) Inventors: Mark Sosebee, Gainesville, GA (US); Gordon Tatro, Gainesville, GA (US); Robert A. Weber, Gainesville, GA (US)

(21) Appl. No.: 18/809,206

(22) Filed: Aug. 19, 2024

Related U.S. Application Data
(60) Provisional application No. 63/537,644, filed on Sep. 11, 2023.
(60) Provisional application No. 63/540,763, filed on Sep. 27, 2023.

(51) Int. Cl. B65D 77/04; A21D 13/32; B65D 77/30

(52) U.S. Cl. CPC B65D 77/04; A21D 13/32; B65D 77/30

(57) ABSTRACT

A packaged product including a plurality of product components, an inner packaging having a plurality of compartments corresponding to the number of product components, and an overwrap. Each of the plurality of product components are individually positioned within a corresponding one of the plurality of compartments. The inner packaging is arranged in a marketable configuration representing the product. The overwrap extends around the inner packaging and secures the product in the marketable configuration.

### INCORPORATION BY REFERENCE TO ANY PRIORITY APPLICATIONS

This application claims priority to U.S. Provisional Patent Application 63/537,644 filed Sep. 11, 2023, and titled REFRIGERATED OR FROZEN FOOD KIT IN PACKAGE HAVING SEPARATE CONTAINERS FOR STORING FOOD PRODUCT COMPONENTS WITH INCOMPATIBLE COOKING PREPARATION REQUIREMENTS, the entirety of which is hereby incorporated by reference and U.S. Provisional Patent Application 63/540,763 filed Sep. 27, 2023, and titled REFRIGERATED OR FROZEN FOOD KIT IN PACKAGE HAVING SEPARATE CONTAINERS FOR STORING FOOD PRODUCT COMPONENTS WITH INCOMPATIBLE COOKING PREPARATION REQUIREMENTS the entirety of which is hereby incorporated by reference.

### BRIEF DESCRIPTION OF THE DRAWINGS

FIG. 1 illustrates a perspective view of an example food packaging in a marketable configuration.

FIG. 2 illustrates a front view of an example food item to be packaged.

FIG. 3A illustrates a top view of an example food packaging.

FIG. 3B illustrates an example side view of the example food packaging of FIG. 3A.

FIG. 3C illustrates another example side view of the example food packaging of FIG. 3A.

FIG. 3D illustrates a perspective view of an example food packaging.

FIG. 3E illustrates a side view of an example food packaging in a marketable configuration.

FIG. 3F illustrates a side view of another example food packaging in a marketable configuration.

FIG. 4A illustrates a top view of another example food packaging.

FIG. 4B illustrates a top view of another example food packaging.

FIG. 4C illustrates a side view of the food packaging of FIG. 4B in an assembled state.

FIG. 4D illustrates a top view of another example food packaging.

FIG. 4E illustrates a side view of the food packaging of FIG. 4D in an assembled state.

FIG. 5A illustrates a top view of an example food packaging with ingredients.

FIG. 5B illustrates a side view of the packaging of FIG. 5A in a marketable configuration.

FIG. 5C illustrates a top view of an example food packaging with ingredients.

FIG. 5D illustrates a side view of the packaging of FIG. 5C in a marketable configuration.

FIG. 5E illustrates a top view of an example food packaging with ingredients.

FIG. 5F illustrates a side view of the packaging of FIG. 5E in a marketable configuration.

FIG. 6A illustrates a perspective view of a food packaging in a marketable configuration secured by an example overwrap.

FIG. 6B illustrates a perspective view of a food packaging in a marketable configuration secured by another example overwrap.

FIG. 6C illustrates a perspective view of the food packaging in a marketable configuration secured by another example overwrap.

FIG. 6D illustrates a perspective view of the food packaging in a marketable configuration secured by another example overwrap.

FIG. 6E illustrates a perspective view of the food packaging in a marketable configuration secured by another example overwrap.

### DETAILED DESCRIPTION

Generally described, aspects of the present disclosure relate to improving product packaging in a marketable configuration, with applications in fields such as packaging for a food item. As described herein, a marketable configuration can represent a product having a plurality of components and/or ingredients positioned in an assembled state or condition. Prepackaged food items can have several drawbacks. For example, some prepackaged food items mix ingredients. This can present issues for consumers with allergies or food aversions and can mix dry ingredients with wet ingredients resulting in soggy dry ingredients. Some prepackaged food items combine ingredients having different reconstitution parameters making it difficult to properly reheat and/or simultaneously reconstitute each ingredient a prepackaged food item. For example, a prepackaged sandwich may include a protein item such as a hamburger patty and a baked good such as a bun. When reheating or reconstituting, the protein ingredient may be under heated while the baked good is overheated. In such embodiments, the protein ingredient may remain cold while the baked good has become dried out and hard. Some prepackaged food items separate each ingredient which a consumer may imply as requiring work to assemble. These and other drawbacks can render a product undesirable as a convenience and/or quick service product. The present disclosure solves these and other problems by providing an inner packaging having a plurality of compartments to individually store an ingredient and an overwrap configured to maintain the inner packaging in a marketable configuration. The inner packaging separates each ingredient thereby preventing cross contamination between ingredients thereby allowing a consumer to selectively remove undesired ingredients and prevent dry ingredients from becoming soggy. The inner packaging can further include predetermined materials and/or perforations based on the contents of each compartment to enable proper reheating and simultaneous reconstitution of different ingredients. The marketable configuration can appeal to a consumer by presenting the product in an assembled state. The marketable configuration can include individually packaging one or more components or ingredients of the product and arranging them in a way to represent a final product in an assembled state. For example, the marketable configuration can visually present a plurality of ingredients as the final food product in the assembled state. The individual components or ingredients can be secured together via an overwrap to maintain the marketable configuration.

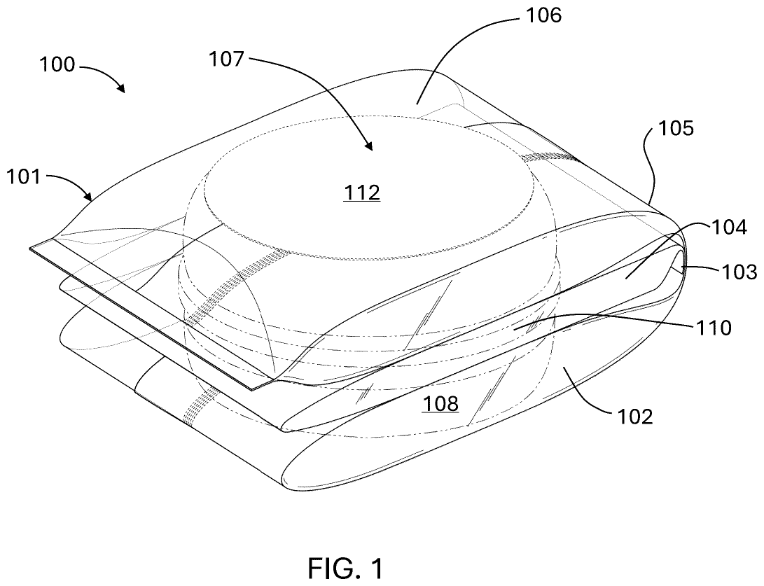

Referring now to FIG. 1, illustrated is an example of a marketable configuration 100 of a product 107 within a packaging 101. The product 107 can include one or more components or ingredients (hereinafter “ingredients”). In some embodiments, as shown in FIG. 1, the product 107 can include a plurality of ingredients. For example, the product 107 can include a first ingredient 108, a second ingredient 110, and a third ingredient 112. In some embodiments, the product 107 can include additional ingredients or fewer ingredients. For example, the second ingredient 110 may be a filling including a plurality of distinct ingredients.

The product 107 can be any product to be marketed and sold to a consumer. In some embodiments, the product 107 can be a food item. For example, as shown in FIG. 1, the product 107 can be a sandwich. In such embodiments, first ingredient 108, the second ingredient 110, and the third ingredient 112 can be distinct elements of a sandwich. For example, the first ingredient 108, the second ingredient 110, and the third ingredient 112 can be a baked good, a produce item, a protein item, a dairy item, and/or the like. In some embodiments, the product 107 can be reheated and/or reconstituted prior to consumption. For example, the product 107 can be a prepackaged food item sold at a convenience store.

A baked good can be a food item made from dough or batter and cooked by baking. For example, and without limitation, a baked good can include breads such as slices of bread and/or buns (e.g., a hamburger bun), cakes, pastries, crackers, biscuits, rice cakes, and the like. In some embodiments, a baked good can be a leavened baked good or an unleavened baked good.

A produce item can be a farm-produced crop such as fruits, vegetables, and or herbs. For example, and without limitation, a produce item can include bananas, strawberries, grapes, tomatoes, lettuce, cucumbers, onions, peppers, olives, sprouts, avocados, parsley, cilantro, and the like. A produce item can also include processed farm-produced crops such as jams, jellies, preserves, marmalade, pickles (i.e., pickled cucumbers), pickled carrots, and the like.

A protein item can include meats or meat substitutes. For example, and without limitation, a protein item can include chicken products (e.g., deli cut slices), pig products (e.g., bacon or pork), cow products (e.g., steak, roast beef, or ground beef/hamburger), turkey (e.g., deli cut slices), fish (e.g., filets), bean patties, tofu, nut butters (e.g., peanut butter and cashew butter), and the like.

A dairy item can include, without limitation, cheese or other products made from animal milk.

Each ingredient can have a unique heating or reheating profile. In some embodiments, the heating or reheating profile may be based on general ingredient categories. For example, baked goods may categorically be reheated differently than a protein item or a dairy item. In some embodiments, ingredients can have a heating or reheating profile based on specific ingredient categories or species of the general ingredient categories. For example, a leavened baked good can have a different heating or reheating profile than an unleavened baked good.

In some embodiments, the first ingredient 108 and the third ingredient 112 can respectively be a baked good. For example, the first ingredient 108 can be a bottom bun and the third ingredient 112 can be a top bun. In some embodiments, the second ingredient 110 can be a filling of one or more other food items to be positioned between the first ingredient 108 and the third ingredient 112.

The packaging 101 can be configured to display the product 107. In some embodiments, the packaging 101 can be transparent. For example, the packaging 101 can be formed of plastics approved by the United States Federal and Drug Administration (FDA) such as polypropylene (PP), polyethylene (PE), polycarbonate.

The packaging 101 can include a plurality of distinct segments or compartments. Each compartment can be a pocket configured to receive a distinct ingredient of the product 107. Each compartment may be sealed after receiving a distinct ingredient. For example, the ingredients may be sealed within a corresponding compartment though one or more of the following methods: vacuum sealing, filing the compartment with a gas (e.g., Carbon Monoxide (CO), a combination of Nitrogen (N₂) and Oxygen (O₂)), or Nitrogen (N₂), heat sealing, zipper sealing, flow wrapping, welding, adhesives, heat shrinking, and/or folding packaging over and sealing with an adhesive label. In some embodiments, one or more of the compartments can include a means for unsealing the compartment. For example, a zipper seal, a permeation, easy peel and/or corner peel. Accordingly, individual ingredients of a product can be preserved within a compartment during shipping and storage and selectively opened by a user. In some embodiments, the packaging 101 can include the same number of compartments as the product 107 has ingredients. For example, the packaging 101 can include three compartments for a product 107 having three ingredients. As shown in FIG. 1, the packaging 101 can include a first compartment 102, a second compartment 104, and a third compartment 106. Accordingly, each ingredient of the product 107 can be individually placed and stored within the packaging 101.

One or more of the plurality of compartments can be selectively treated or prepared to preserve the contents. In some embodiments, the one or more of the plurality of compartments can be selectively treated or prepared based on an ingredient predetermined to be contained within the compartment. For example, a compartment predetermined to contain an ingredient may include perforations to allow moisture to escape the compartment. In some embodiments, one or more of the plurality of compartments may include microperforations. In some embodiments, the one or more of the plurality of compartments may be treated with a gas flush. For example, the plurality of compartments may be filed with a gas including Carbon Monoxide (CO), a combination of Nitrogen (N₂) and Oxygen (O₂), or Nitrogen (N₂),

In some embodiments, one or more of the compartments can be secured together via a tab. The tabs can be thin bodied members extending between two adjacent compartments. The tabs can be flexible and configured to be folded. For example, as shown in FIG. 1, the first compartment 102 can be secured to the second compartment 104 via a first tab 103 and the third compartment 106 can be secured to the first compartment 102 via a second tab 105.

The packaging 101 can be positioned and/or arranged in a marketable configuration to present the ingredients in an assembled state of the product 107. For example, in some embodiments the product 107 can be a food item such as a sandwich. In such embodiments, the packaging 101 can be arranged to position the various ingredients in an order representing an assembled sandwich corresponding to the marketable configuration of the product 107. The marketable configuration can include stacking at least one ingredient between two baked goods. For example, the marketable configuration of a sandwich can include stacking or vertically arranging a plurality of ingredients. In some embodiments, the marketable configuration can include a first baked good, a first filling ingredient, a second filling ingredient, a third filling ingredient, and a second baked good. Additional or fewer filling ingredients can be included. The filling ingredients can be selected from a produce item, a protein item, and/or a dairy item. The filling can include one or more produce items, one or more protein items, and/or one or more dairy items. In some embodiments, the filling can further include a baked good.

In some embodiments, the product 107 may be offered for sale directly to consumers. For example, the product 107 may be sold at a convenience store such as a gas station, a hotel concierge service, a vending machine, and/or the like. Arranging the product 107 in a marketable configuration may increase its appeal to consumers. Transparent plastic materials can also allow the consumer to see the quality of the food items contained therein. The distinct ingredients of the product 107 can be properly reheated and/or simultaneously reconstituted.

In some embodiments, the product 107 may be sold to a business and/or distributed to a franchisee. In such embodiments, the product 107 can be quickly examined by the recipient and prepared for sale to a consumer. Providing a recipient with the product 107 in a marketable configuration 100 can increase efficiency and reduce costs by enabling preparation and assembly of the product 107 in a first location and heating and/or otherwise preparing the product 107 for sale in a second location. For example, distributing the product 107 arranged in the marketable configuration 100 to a business or a franchisee can minimize costs by preparing and packaging the product 107 in a first location with lower labor costs and exporting the product 107 to a second location with higher labor costs.

In some embodiments, the product 107 may be stored in a refrigerator or freezer. In such embodiments, it may be desirable to reheat the product 107. In some embodiment, the packaging 101 may be formed of a material configured to withstand temperatures ranging between 28 degrees Fahrenheit to at least 180 degrees Fahrenheit. Accordingly, the packaging 101 may be, freezer safe, microwave safe, and/or heat lamp/oven safe. In some embodiments, each compartment may be made of a distinct material and/or with distinct features. In some embodiments, each compartment may be predetermined to contain a specific food item. For example, a compartment may be predetermined to contain a baked good, a produce item, a protein item, or a dairy item. Accordingly, each compartment may be formed of a predetermined material optimized for the predetermined ingredient. In some embodiments, the collection of predetermined materials can be optimized for proper reheating and/or simultaneous reconstitution of the corresponding ingredients. Thus, baked goods, produce items, protein items, and dairy items can be properly reheated and/or simultaneously reconstituted without over or under heating any of the distinct ingredients. This can advantageously provide an easy to reheat or reconstitute product. In some embodiments, one or more of the compartments can be separated to be selectively reheated and/or reconstituted.

Each ingredient of the product 107 can be stored in an individual distinct compartment. Individually storing each ingredient of the product 107 in a distinct compartment can separate wet and dry ingredients thereby preventing dry ingredients from becoming soggy prior to use by the user. Additionally, individually storing the ingredients can advantageously avoid contamination from one ingredient to another. The distinct compartments may be selectively removed from the packaging 101. Selective removal of the distinct compartments may be advantageous because a consumer may desire to use/have fewer than all of the ingredients of the product 107 thereby allowing the consumer to discard unwanted ingredients. In some embodiments, a consumer may desire to not reheat one or more of the ingredients. For example, a consumer may desire to maintain one or more of the baked goods, produce items, protein items, and/or dairy items in a chilled state. Additionally and/or alternatively, a consumer may desire to heat the ingredients at different temperatures or heat the ingredients according to a different heating method. This can be advantageous when reheating a baked good and a protein item which can react/reheat differently in a microwave. Accordingly, the distinct compartments can be selectively reheated.

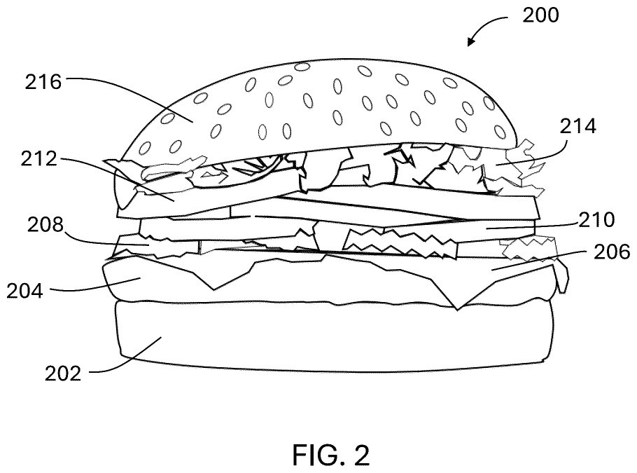

FIG. 2 illustrates an example product 200 having a plurality of ingredients. The product 200 can be the same or similar to the product 107 described above. In some embodiments, the product 200 can include a first baked good, one or more produce items, one or more dairy items, one or more protein items, and a second baked good. For example, the product 200 can be a sandwich having a first ingredient 202, a second ingredient 204, a third ingredient 206, a fourth ingredient 208, a fifth ingredient 210, a sixth ingredient 212, a seventh ingredient 214, and an eight ingredient 216. As shown in FIG. 2, the first ingredient 202 can be a first baked good such as a bottom bun. The second ingredient 204 can be a protein item such as a hamburger patty. The third ingredient 206 can be a dairy item such as a slice of cheese. The fourth ingredient 208 can be a first produce item such as slices of pickles. The fifth ingredient 210 can be a second produce item such as slices of onion. The sixth ingredient 212 can be a third produce item such as slices of tomato. The seventh ingredient 214 can be a fourth produce item such as lettuce. The eight ingredient 216 can be a second baked good such as a top bun. In some embodiments, each of the ingredients can be individually stored within a compartment and arranged to represent the product 200 in a marketable configuration. Accordingly, the plurality of ingredients can be arranged to represent a cheeseburger in a marketable configuration.

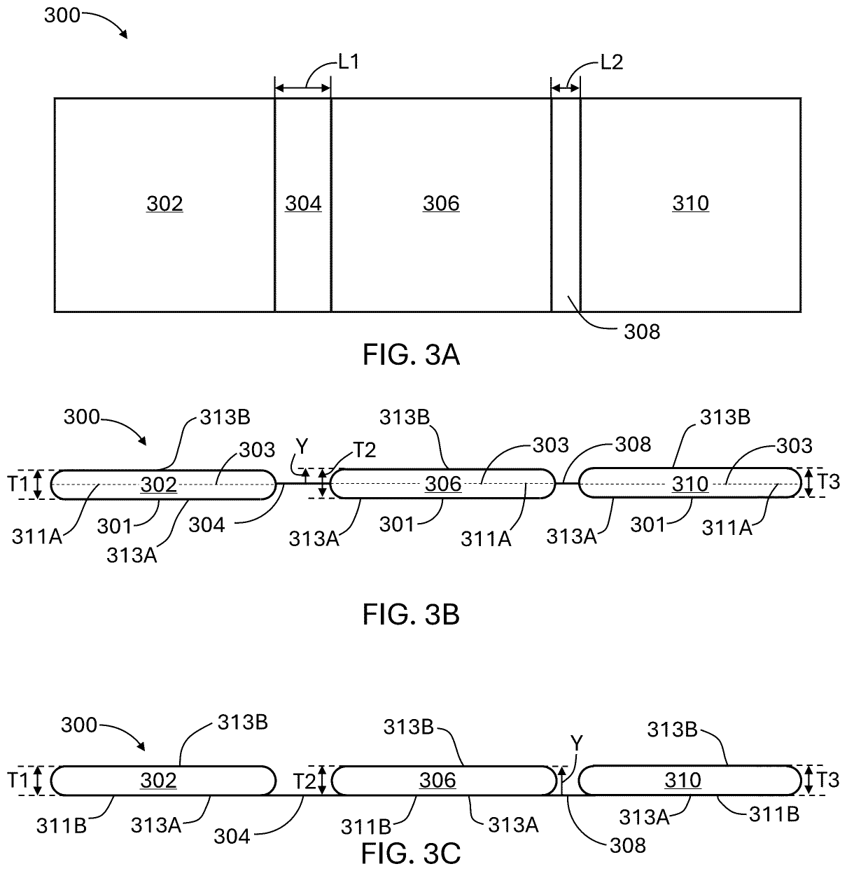

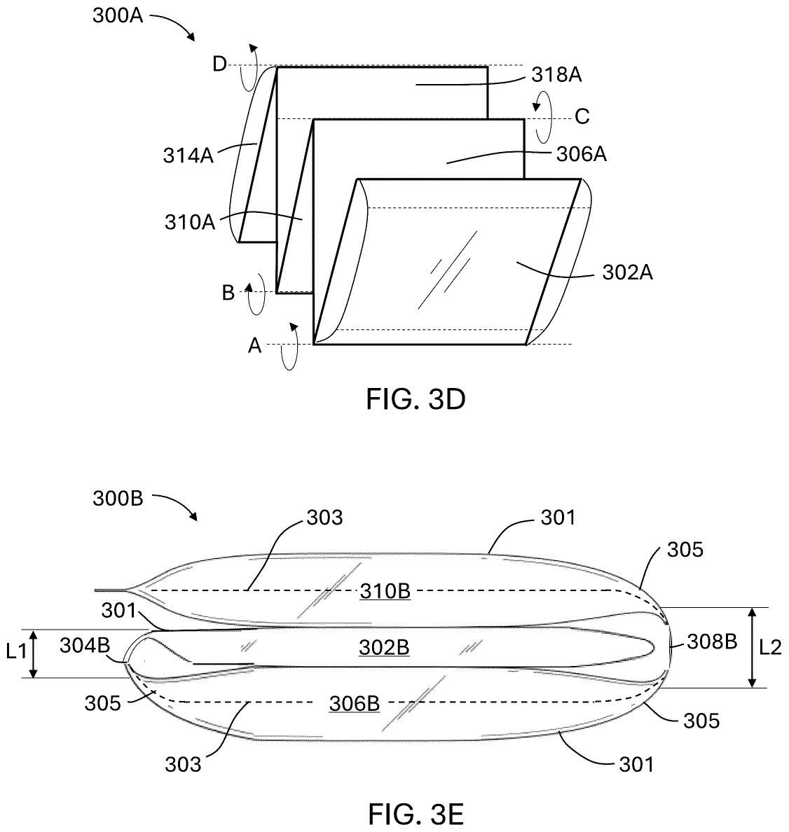

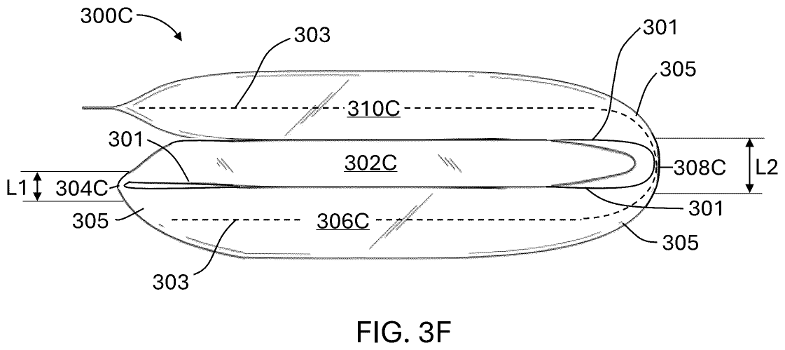

FIGS. 3A-3C illustrate an example packaging 300 in an unassembled state. The packaging 300 can correspond to the packaging 101 described above before receiving the ingredients of the product 107. For example, the compartments may be empty and the packaging 300 may be flat and/or in a linear arrangement. FIG. 3A illustrates a top view of the packaging 300. FIG. 3B illustrates an example of a side view of the packaging 300 with one or more tabs extending along a midpoint 303 of the packaging 101. FIG. 3C illustrates another example of a side view of the packaging 300 with one or more tabs extending along an edge 301 of the packaging 300.

As shown in FIGS. 3A-3C, the packaging 300 can include a plurality of distinct compartments. The plurality of distinct compartments can include a first distinct compartment 302, a second distinct compartment 306, and a third distinct compartment 310. In some embodiments, fewer or additional distinct compartments may be provided. As further shown in FIGS. 3A-3C, the first distinct compartment 302 and the second distinct compartment 306 can be connected by a first tab 304 and the second distinct compartment 306 and the third distinct compartment 310 can be connected by a second tab 308. In some embodiments, the first tab 304 and the second tab 308 may extend along a common plane. For example, as shown in FIG. 3B, the first tab 304 and the second tab 308 may extend along a plane positioned along the midpoint 303 of the thickness of the packaging 300. Alternatively, as shown in FIG. 3C, the first tab 304 and the second tab 308 may extend along a plane positioned along an edge 301 of the packaging 300. In some embodiments, the edge 301 can correspond to a sidewall of the packaging 300. For example, the edge 301 can be a bottom or top sidewall of the packaging 300. In some embodiments, the first tab 304 and the second tab 308 may extend along different planes extending through the thickness of the packaging 300.

In some embodiments, the distinct compartments may have a uniform length and width. The uniform length and width of the distinct compartments may enable superior stacking. For example, each distinct compartment can be configured to be aligned with respect to the other distinct compartments. As shown in FIGS. 3B-3C, each of the distinct compartments may have a thickness. For example, the first distinct compartment 302 may have a first thickness T1, the second distinct compartment 306 may have a second thickness T2, and the third distinct compartment 310 may have a third thickness T3. In some embodiments, the thickness of the distinct compartment may correspond to the expected, predetermined, corresponding, and/or identified contents (i.e., ingredient) for each distinct compartment. Accordingly, the thickness of the distinct compartment may be individual and unique. In some embodiments, the thickness of two or more of the distinct compartments may be the same. For example, if the contents to be provided to the two or more distinct compartments are the same (e.g., two hamburger patties). In some embodiments, the thicknesses of the distinct compartments may be unique and different from the other distinct compartments.

As shown in FIGS. 3A-3C, each tab can have a length. For example, as shown in FIG. 3A, the first tab 304 can have a first length L1 and the second tab 308 can have a second length L2. In some embodiments, the lengths of each tab can be the same. For example, the packaging 300 can be produced having a number of distinct compartments, each distinct compartment being connected to two adjacent distinct compartments by tabs having a uniform length. This may be advantageous to manufacture and produce packaging 300 to accommodate a variety of various products and/or marketable configurations.

In some embodiments, the lengths of each tab may be unique. For example, the first length L1 may be different from the second length L2. As shown in FIGS. 3A-3C, the first length L1 may be greater than the second length L2. In some embodiments, the length of each tab may be sufficiently long to arrange the adjacent compartments in a stacked configuration. In some embodiments, the lengths of the tabs can depend on one or more of the following factors: (1) the position of the tabs relative to the adjacent distinct compartments (e.g., along an edge, along the midline, or along another position of the thickness of the packaging); (2) the thickness of the adjacent distinct compartments and/or the thickness of the ingredients to be contained within the adjacent distinct compartments; (3) whether the adjacent distinct compartments have a deformable section; and (4) whether one or more distinct compartments are placed between the adjacent distinct compartments.

In some examples, the length of each tab may be defined by the following relationship: L=Y1+Y2+C+F. L can be the length of the tab extending between a first distinct compartment and a second distinct compartment. For example, in some embodiments, L can be the length L1 of the first tab 304 extending between the first distinct compartment 302 and the second distinct compartment 306. Additionally and/or alternatively, L can be the length L2 of the second tab 308 extending between the second distinct compartment 306 and the third distinct compartment 310. Y1 can be a distance between a tab height 311 and a contact surface 313 of the first compartment. Y2 can be a distance between a tab height 311 and a contact surface 313 of the second compartment. The tab height can be the position of the tab relative to the thickness of the adjacent compartments. For example, in some embodiments, the tab height 311A can be positioned at a midpoint of the thickness of the adjacent compartments as shown in FIG. 3B. Additionally and/or alternatively, the tab height 311B can be positioned at a maximum or minimum part of the thickness of the adjacent compartments. For example, as shown in FIG. 3C, the tab height 311B can be at the same position as the contact surface 313A. Alternatively, as shown in FIG. 3C, the tab height 311B can be opposite the contact surface 313B of the adjacent compartments. The contact surface 313 can be an edge or surface of the respective adjacent compartments that are configured to contact one another in the marketable configuration. For example, the contact surface 313A can correspond to a marketable configuration when the bottom edges of the adjacent compartments are configured to contact each other. Additionally and/or alternatively, the contact surface 313B can correspond to a marketable configuration when the top edges of the adjacent compartments are configured to contact each other. F can be the thicknesses of fillings to be positioned between the adjacent compartments. For example, in some embodiments, F can account for one or more layers of subcomponents positioned between the first distinct compartment 302 and the second distinct compartment 306. C can be a constant value. In some embodiments, C can be a nominal length configured to provide slack to the tab and/or to allow for variability in the thicknesses of the components or ingredients.

In some examples, the nominal length can be sufficient to allow adjacent compartments to be positioned into the marketable configuration when the lengths of Y1, Y2, and F are zero. This can be the case when the tab height extends along the contact surfaces of a first compartment and a second compartment such that Y1 and Y2 are zero and when there are no fillings to be placed between the first compartment and the second compartment in the marketable configuration. In some embodiments, C can have a length of 1/16 inch to 1/14 inch. For example, C can be 1/16 inch, ⅛ inch, ¼ inch, or any length therebetween.

In some examples, the nominal length can be percentage of the summed length of Y1, Y2, and F, when the summed length of Y1, Y2, and F is not zero. For example, C can be between 0% and 10% of the summed length of Y1, Y2, and F (i.e., C can be 0.01, 0.02, 0.03, 0.04, 0.05, 0.06, 0.07, 0.08, 0.09, or 0.1 times the summed length of Y1, Y2, and F). In such examples, the resulting length of each tab may be defined by the following relationship: L=P(Y1+Y2+F), wherein P is a multiplier for providing a desired length L. In some examples, P can be a value representing up to a ten percent increase in length of the summed length of Y1, Y2, and F. For example, P can be 1, 1.01, 1.02, 1.03, 1.04, 1.05, 1.06, 1.07, 1.08, 1.09 and 1.1. Accordingly, P can provide an effective length of the tab L that is between 100% and 110% of the summed length of Y1, Y2, and F. P can be any value configured to provide a desired buffer in the tab length. In such examples, C can be defined as (P−1) (Y1+Y2+F). As described above, L=Y1+Y2+C+F and L=P(Y1+Y2+F). Thus,

$$\begin{matrix}Y 1 + Y 2 + C + F = P ( Y 1 + Y 2 + F ) \\ C = P ( Y 1 + Y 2 + F ) - ( Y 1 + Y 2 + F ) \\ C = P ( Y 1 + Y 2 + F ) - ( 1 ) ( Y 1 + Y 2 + F ) \\ C = ( P - 1 ) ( Y 1 + Y 2 + F )\end{matrix}$$

The following are examples of possible marketable configurations and corresponding tab lengths.

As shown in FIG. 3B, the tab height 311A can be arranged along the midpoint of the thicknesses of the first distinct compartment 302, the second distinct compartment 306, and the third distinct compartment 310. In some embodiments, the contact surface 313A of the first distinct compartment 302 can be configured to contact the contact surface 313A of the second distinct compartment 306 and the contact surface 313B of the second distinct compartment can be configured to contact the second contact surface 313B of the third distinct compartment. In such embodiments, the distance between the tab height 311A and the corresponding contact surfaces 313A, 313B can be half of the respective thicknesses. Accordingly, the length L1 of the first tab 304 can be half the thickness of the first distinct compartment 302 (i.e., the distance between the tab height 311A and the contact surface 313A of the first distinct compartment 302), half the thickness of the second distinct compartment 306 (i.e., the distance between the tab height 311A and the contact surface 313A of the second distinct compartment 306), and a nominal length (e.g., a constant predetermined value or a predetermined percentage of the summed length of half the thickness of the first distinct compartment 302 and half the thickness of the second distinct compartment 306) In some examples, the tab length L1 can also include the thickness of ingredients configured to be placed between the first distinct compartment 302 and the second distinct compartment 306. The length L2 of the second tab 308 can be half the thickness of the second distinct compartment 306 (i.e., the distance between the tab height 311A and the contact surface 313B of the second distinct compartment 306), half the thickness of the third distinct compartment 310 (i.e., the distance between the tab height 311A and the contact surface 313B of the third distinct compartment 310), and a nominal length (e.g., a constant predetermined value or a predetermined percentage of the summed length of half the thickness of the second distinct compartment 306 and half the thickness of the third distinct compartment 310). In some examples, the tab length L2 can also include the thickness of ingredients configured to be placed between the second distinct compartment 306 and the third distinct compartment 310.

As shown in FIG. 3C, in some embodiments the tab height 311B of the first tab 304 can be arranged along the contact surface 313A of the first distinct compartment 302 and the second distinct compartment 306. In some embodiments, the contact surface 313A of the first distinct compartment 302 can be configured to contact the contact surface 313A of the second distinct compartment 306 and the contact surface 313B of the second distinct compartment can be configured to contact the second contact surface 313B of the third distinct compartment. Accordingly, the length L1 of the first tab 304 can be a nominal length of a constant predetermined value (e.g., ⅛ inch) because the distance between the tab height 311B and the contact surface 313A of the first distinct compartment 302 and the distance between the tab height 311B and the contact surface 313A of the second distinct compartment 306 is zero. In some examples, the tab length L1 can also include the thickness of ingredients configured to be placed between the first distinct compartment 302 and the second distinct compartment 306. In such embodiments, the nominal length can alternatively be a predetermined percentage of the summed length of the thickness of the ingredients configured to be placed between the compartments. The length L2 of the second tab 308 can be the thickness of the second distinct compartment 306 (i.e., the distance between the tab height 311B and the contact surface 313B of the second distinct compartment 306), the thickness of the third distinct compartment 310 (i.e., the distance between the tab height 311B and the contact surface 313B of the third distinct compartment 310), and a nominal length of (e.g., a constant predetermined value or a predetermined percentage of the summed length of the thickness of the second distinct compartment 306 and the thickness of the third distinct compartment 310). In some examples, the tab length L2 can also include the thickness of ingredients configured to be placed between the second distinct compartment 306 and the third distinct compartment 310.

FIG. 3D illustrates an example packaging 300A being folded about respective axes. The respective axes can include a first axis A, a second axis B, a third axis C, and a fourth axis D. The packaging 300A can be the same or similar to the packaging 300 described above. As shown in FIG. 3D, the packaging 300A can include additional distinct compartments. As further shown in FIG. 3D, the distinct compartments can include a first distinct compartment 302A, a second distinct compartment 306A, a third distinct compartment 310A, a fourth distinct compartment 314A, and a fifth distinct compartment 318A. Each of the distinct compartments may be connected via tabs. As shown in FIG. 3C, the distinct compartments may be folded using a series of alternating folds about the respective axes to form a marketable configuration. In some embodiments, the alternating folds about the respective axes may represent parallel pleats resembling an accordion or a Z-fold. The accordion or Z-fold can advantageously accommodate a packaging including any number of distinct compartments. In some embodiments, the distinct compartments may be folded according to another pattern. For example, and without limitation, the packaging 300A can be folded according to a bifold, a trifold, a gate fold, a French fold, or a roll fold.

A bifold can be used to fold a packaging including two distinct compartments. The bifold can be created by folding the two distinct compartments about a single axis. In such embodiments, the two distinct compartments can be stacked and coupled together via a single tab.

A trifold can be used to fold a packaging including three distinct compartments (e.g., as shown in FIG. 3A). The three distinct compartments can include a first compartment, a second compartment, and a third compartment. A first tab can connect the first compartment and the second compartment. A second tab can connect the second compartment and the third compartment. Accordingly, the three distinct compartments may be operatively coupled and arranged such that the second compartment is positioned between the first compartment and the third compartment. The trifold can be created by folding the first compartment towards the second compartment about a first axis corresponding to the first tab and subsequently folding the third compartment towards the second compartment about a second axis corresponding to the second tab. In an assembled state, the first compartment may be positioned between the second compartment and the third compartment.

A gate fold can be used to fold a packaging including at least three distinct compartments. The at least three distinct compartments can include a first compartment, a second compartment, and a third compartment. A first tab can connect the first compartment and the second compartment. A second tab can connect the second compartment and the third compartment. Accordingly, the three distinct compartments may be operatively coupled and arranged such that the second compartment is positioned between the first compartment and the third compartment. The gate fold can be created by folding the first compartment towards the second compartment about a first axis corresponding to the first tab and folding the third compartment towards the second compartment about a second axis corresponding to the second tab. In an assembled state, the first compartment and the third compartment may be coplanar and extend along a surface of the second compartment. In some embodiments, the second compartment can be wider than the widths of the first compartment and/or the third compartment. For example, the second compartment may have a width (i.e., the dimension extending in the direction between the first compartment and the third compartment) at least as long as the sum of the width of the first compartment and the width of the third compartment. In some embodiments, the gate fold may be used if an ingredient is larger than the other ingredients. For example, a gate fold may be used if a protein item has a width greater than the widths of the baked goods. In some embodiments, the gate fold may be used if an ingredient contains a large volume. For example, a gate fold may be used if a produce item (e.g., shredded lettuce) has a quantity sufficient to fill a volume but not a predetermined shape. Accordingly, the distinct compartment can be made wider/longer to minimize the requisite thickness.

A French fold can be used to fold a packaging including four distinct compartments. The four distinct compartments can include a first compartment, a second compartment, a third compartment, and a fourth compartment. The four distinct compartments can be arranged in a two-by-two grid. For example, the first compartment may be positioned laterally across from the second compartment, above the third compartment, and diagonally across from the fourth compartment. The French fold can be created by folding the first compartment and third compartment towards the second compartment and fourth compartment, respectively, and subsequently folding the first compartment towards the third compartment or the second compartment towards the fourth compartment, respectively.

A roll fold can be used to fold a packaging including at least three distinct compartments. The at least three distinct compartments can include a first compartment, a second compartment, and a third compartment. A first tab can connect the first compartment and the second compartment. A second tab can connect the second compartment and the third compartment. Accordingly, the three distinct compartments may be operatively coupled and arranged such that the second compartment is positioned between the first compartment and the third compartment. The roll fold can be created by iteratively folding the last compartment towards the next proximal compartment. For example, folding the third compartment towards the second compartment about a second axis corresponding to the second tab and subsequently folding the second compartment and third compartment towards the first compartment about a first axis corresponding to the first tab. In an assembled state, the last compartment (e.g., the third compartment) may be positioned in the center of the stacked compartments.

FIG. 3E illustrates an example packaging 300B folded into a marketable configuration. The packaging 300B can include a first distinct compartment 302B, a second distinct compartment 306B, and a third distinct compartment 310B. As shown in FIG. 3E, the packaging 300B can be folded according to the trifold described above, wherein the first distinct compartment 302B and the third distinct compartment 310B are folded towards the second distinct compartment 306B such that the first distinct compartment 302B is positioned between the second distinct compartment 306B and the third distinct compartment 310B. As further shown in FIG. 3E, the first tab 304B can extend along the midpoint 303 of the second distinct compartment 306B and the edge 301 of the first distinct compartment 302B. The second tab 308B can extend along the midpoint 303 of the second distinct compartment 306B and of the third distinct compartment 310B. In some embodiments, the packaging 300B can include one or more deformable sections 305. The one or more deformable sections 305 can be deformed and oriented toward an adjacent/connected distinct section thereby minimizing the length of the tab. As shown in FIG. 3E, the length of the first tab 304B can correspond to the thickness of the first distinct compartment 302B because the edge 301 is positioned on the exterior of the packaging 300. As further shown in FIG. 3E, the second tab 308B can have a thickness corresponding to at least the entire thickness of the first distinct compartment 302B because the first distinct compartment 302B is positioned between the second distinct compartment 306B and the third distinct compartment 310B. The length of the second tab 308B can be further adjusted by the presence of the one or more deformable sections 305. Without the one or more deformable section 305, the length of the second tab 308B can further include half the thickness of the second distinct compartment 306B and half the thickness of the third distinct compartment 310B when extending along the midpoint 303.

FIG. 3F illustrates an example packaging 300C folded into a marketable configuration. The packaging 300C can include a first distinct compartment 302C, a second distinct compartment 306C, and a third distinct compartment 310C. As shown in FIG. 3F, the packaging 300C can be folded according to the trifold described above, wherein the first distinct compartment 302C and the third distinct compartment 310C are folded towards the second distinct compartment 306C such that the first distinct compartment 302C is positioned between the second distinct compartment 306C and the third distinct compartment 310C. As further shown in FIG. 3F, the first tab 304C can extend along the edge 301 of the first distinct compartment 302C and the second distinct compartment 306C. The second tab 308C can extend along the edge 301 of the second distinct compartment 306C and of the third distinct compartment 310C. As shown in FIG. 3F, the length of the first tab 304C can be minimal and approach a negligible length because the edge 301 is positioned on the interior of the packaging 300C. As further shown in FIG. 3F, the second tab 308C can have a thickness corresponding to the entire thickness of the first distinct compartment 302C because the first distinct compartment 302C is positioned between the second distinct compartment 306C and the third distinct compartment 310C and the second tab 308C extends along the edge 301 positioned on the interior of the packaging 300C.

Accordingly, in some embodiments, the first tab 304 can extend along the edge 301 and/or the midpoint 303. Likewise, the second tab 308 can extend along the edge 301 and/or the midpoint 303. The length of the tabs can depend on one or more of the following factors: (1) the position of the tabs relative to the adjacent distinct compartments (e.g., along an edge, along the midline, or along another position of the thickness of the packaging); (2) the thickness of the adjacent distinct compartments and/or the thickness of the ingredients to be contained within the adjacent distinct compartments; and (3) whether the distinct compartments have one or more deformable sections 305. In some embodiments, the one or more tabs can have a length corresponding to at least the thickness of half of the adjacent distinct compartments. For example, the one or more tabs can have a length corresponding to half the thickness of the adjacent distinct compartments when the one or more tabs extend along the midpoint 303. In some embodiments, the one or more tabs can have a length corresponding to at least the thickness of a distinct compartment and/or the thickness of an ingredient to be contained within the compartment positioned between the adjacent distinct compartments. For example, the one or more tabs can have a length corresponding to the entire thickness of a distinct compartment and/or the entire thickness of an ingredient to be contained within the compartment positioned between the adjacent distinct compartments when the one or more tabs extend along the edge 301 and the edge 301 is positioned on the interior of the packaging 300. Alternatively, the one or more tabs can have a length corresponding to the entire thickness of the adjacent distinct compartments and the one or more distinct compartments positioned between the adjacent distinct compartments when the one or more tabs extend along the edge 301 and the edge 301 is positioned on the exterior of the packaging 300.

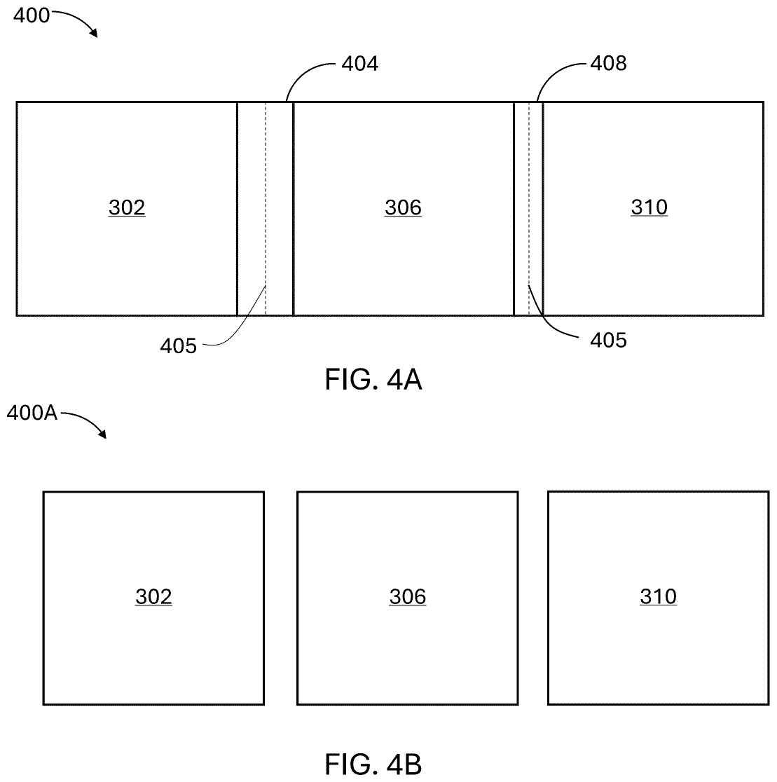

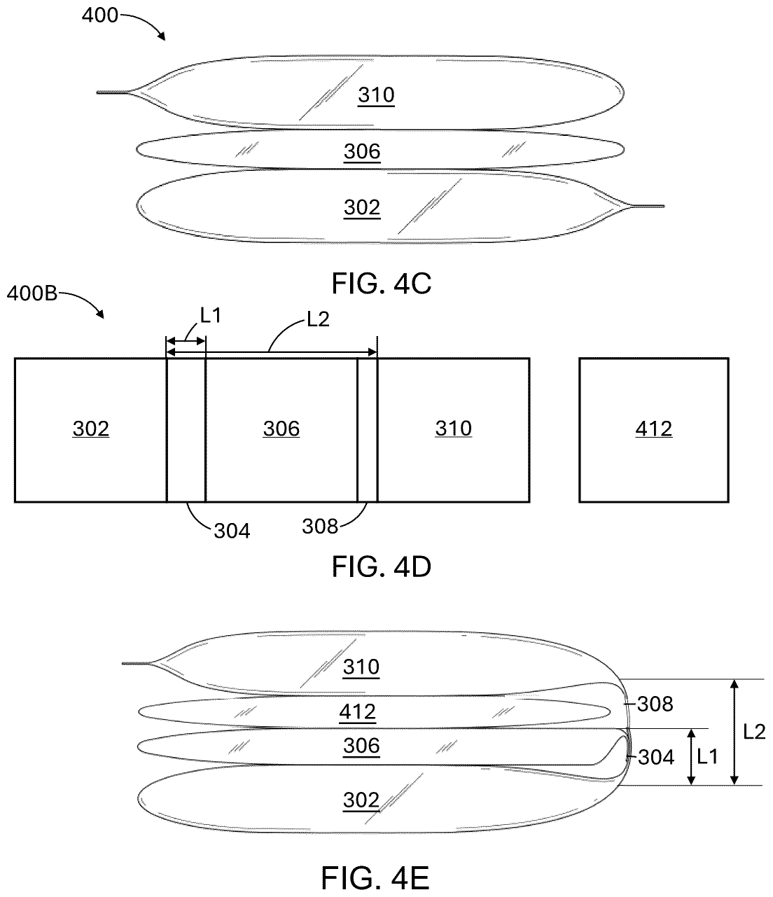

FIG. 4A illustrates a top view of an embodiment of a packaging 400. In some embodiments, the packaging 400 can be similar to the packaging 300 described above. As shown in FIG. 4A, the first tab 404 and the second tab 408 can further include a perforated edge 405. The perforated edges 405 may enable one or more of the distinct compartments to be removed. For example, the first distinct compartment 402 may be removed from the second distinct compartment 406 via the perforated edge 405 on the first tab 404. Additionally and/or alternatively, the third distinct compartment 410 may be removed from the second distinct compartment 406 via the perforated edge 405 on the second tab 408. Accordingly, the perforated edges 405 may advantageously allow a consumer to selectively remove one or more of the distinct compartments from the remainder of the packaging 400. As discussed above, the consumer may not want to consume one or more of the ingredients provided in the packaging 400 and/or may desire to reheat only a subset of the provided ingredients. Accordingly, the consumer may selectively remove one or more distinct compartments for reheating. As discussed above, the packaging can include additional distinct compartments. Accordingly, the packaging 400 can include any number of distinct compartments corresponding to the number of ingredients included in the product.

FIG. 4B illustrates a top view of an embodiment of a packaging 400A. The packaging 400A can be substantially similar to the packaging 400 described above. As shown in FIG. 4B, the packaging 400B does not include the tabs such that the distinct compartments are individual and non-connected components. Accordingly, the consumer does not need to selectively remove the distinct compartments. The distinct compartments can still be presented in a marketable configuration without the tabs as shown in FIG. 4C. In some embodiments, the distinct layers of the packaging 400A can be glued and/or adhered together in the marketable configuration. For example, a dab or dot of glue can be applied to the packaging between individual ingredients. In such embodiments, the product can be secured in the marketable configuration.

FIG. 4D illustrates a packaging 400B similar to packaging 300 with the addition of one or more non-connected distinct compartment 412. Accordingly, in some embodiments two or more distinct compartments may be connected via a tab while one or more distinct compartments are non-connected. As shown in FIG. 4E, the one or more non-connected distinct compartments 412 can be placed between two connected distinct compartments in the marketable configuration. In some embodiments, the one or more non-connected distinct compartments 412 can include a component to remain separate from the remaining components. For example, the one or more non-connected distinct compartments 412 can include a produce item or dairy item to remain separate during a reheating process.

As shown in FIGS. 4D-4E, the first tab 304 can have a length L1. The second tab 308 can have a length L2. In some embodiments, the length L1 can depend on one or more of the following factors: (1) the position of the first tab 304 relative to the first distinct compartment 302 and the second distinct compartment 306 (e.g., along an edge, along the midline, or along another position of the thickness of the packaging); (2) the thickness of the first distinct compartment 302 and the second distinct compartment 306 and/or the thickness of the ingredients to be contained within the first distinct compartment 302 and the second distinct compartment 306; and (3) whether the distinct compartments have a deformable section. As shown in FIG. 4E, the length L1 can be at least the thickness of the second distinct compartment 306. In some embodiments, the length L2 can depend on one or more of the following factors: (1) the position of the second tab 308 relative to the first distinct compartment 302 and the third distinct compartment 310 (e.g., along an edge, along the midline, or along another position of the thickness of the packaging); (2) the thickness of the first distinct compartment 302 and the third distinct compartment 310 and/or the thickness of the ingredients to be contained within the first distinct compartment 302 and the third distinct compartment 310; (3) whether the distinct compartments have a deformable section; and (4) whether one or more distinct compartments are placed between the first distinct compartment 302 and the third distinct compartment 310. As shown in FIG. 4E, the length L2 can be at least the thickness of the second distinct compartment 306 and the one or more non-connected distinct compartments 412.

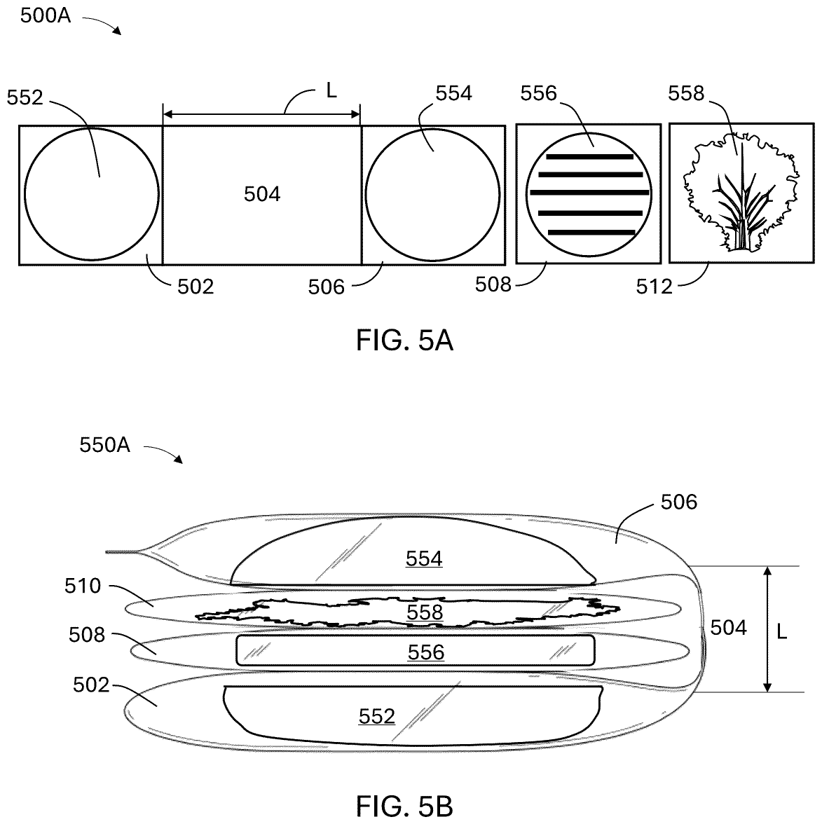

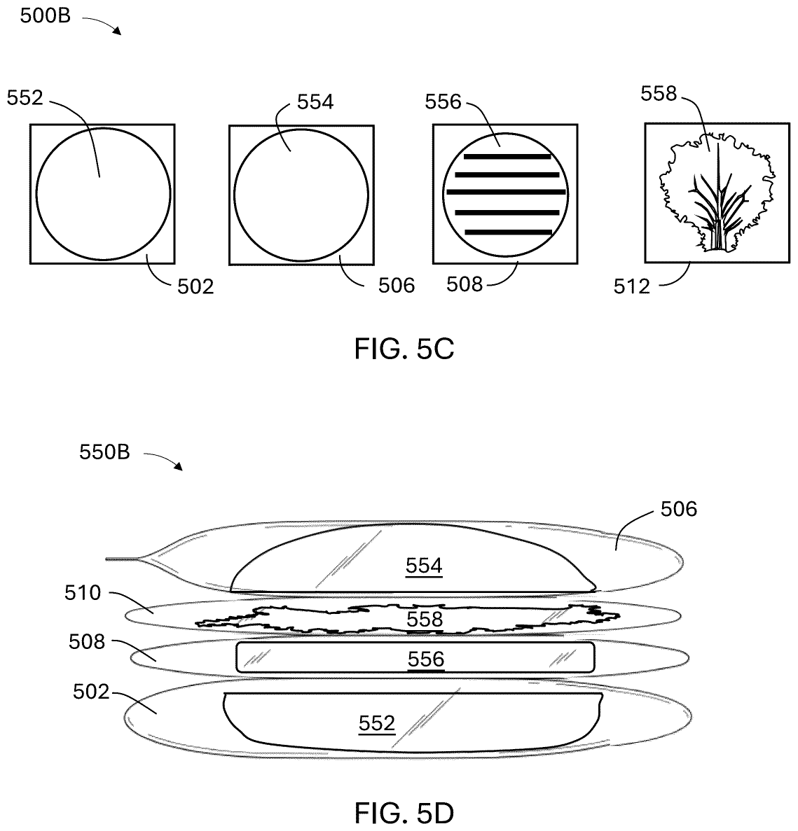

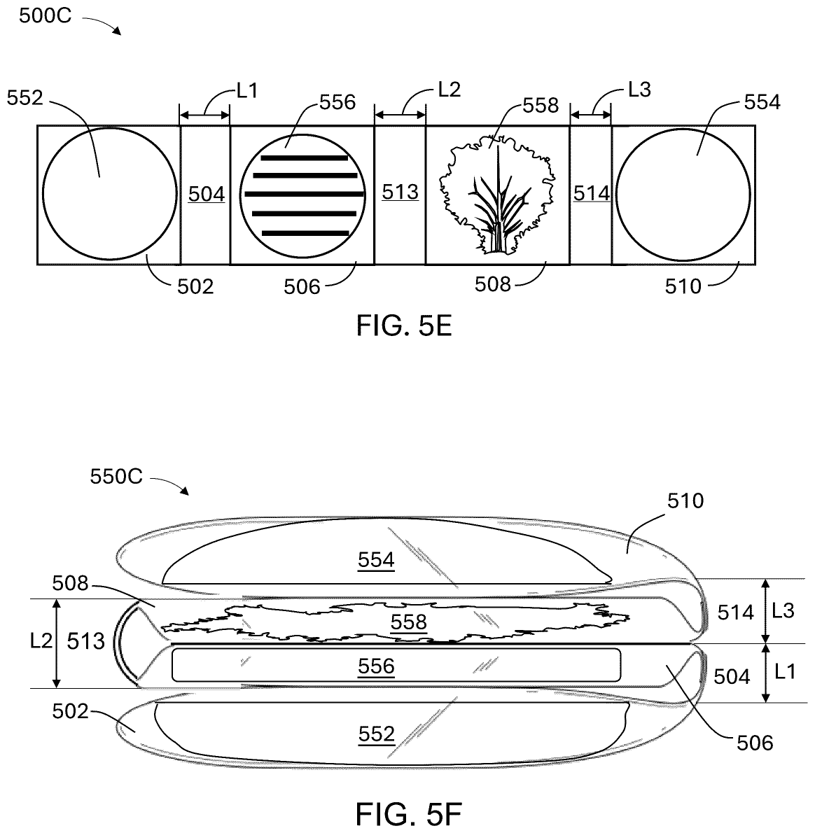

FIGS. 5A-5B illustrate a first embodiment of a packaging 500A of a product 550A wherein only two compartments are connected. For example, in some embodiments, only the compartments containing the baked goods are attached. The remaining components are contained within non-connected compartments.

As shown in FIGS. 5A-5B, the packaging 500A can include a first distinct compartment 502, a second distinct compartment 506, and a tab 504 extending between the first distinct compartment 502 and the second distinct compartment 506. As shown in FIG. 5B, the packaging 500A can include a bifold as described above. The packaging 500A can further include a plurality of non-connected compartments. For example, the packaging 500A can include a third distinct compartment 508 and a fourth distinct compartment 510 that are not connected to the first distinct compartment 502 or the second distinct compartment 506. In some embodiments, additional or fewer non-connected compartments may be included. The tab 504 has a length L. The length L of the tab 504 can be at least as long as the entire thickness of the plurality of non-connected compartments (e.g., the third distinct compartment 508 and the fourth distinct compartment 510). For example, the length L of the tab 504 can be the distance between the tab height and the contact surface of the first distinct compartment 502, the distance between the tab height and the contact surface of the second distinct compartment 506), and a nominal length including the sum of the thicknesses of the third distinct compartment 508 and the fourth distinct compartment 510.

The product 550A can include one or more baked goods and a filling. For example, the one or more baked goods can include a first baked good 552 and a second baked good 554. The filling can include one or more protein items 556, one or more produce items 558 and/or dairy items. In some embodiments, the first baked good 552 can be a bottom bun, a slice of bread, or other baked good configured to form a base of a food item. In some embodiments, the second baked good 554 can be a top bun, a slice of bread, or other baked good configured to form a top of a food item. In some embodiments, the one or more protein items 556 can be one or more distinct slices, fillets, or patties. For example, the one or more protein items 556 can be a hamburger patty. In some embodiments, the one or more produce items 558 and/or dairy items can be bananas, strawberries, grapes, tomatoes, lettuce, cucumbers, onions, peppers, olives, sprouts, avocados, parsley, cilantro, and/or cheese. For example, the one or more produce items 558 can be lettuce. Although only one protein item and one produce item are shown, the hamburger patty and the lettuce are non-limiting examples. The product 550A can include any number and/or combination of items. In some embodiments, the number and combination of items may be determined based on an intended target consumer.

The first baked good 552 can be placed within the first distinct compartment 502 and the second baked good 554 can be placed within the second distinct compartment 506. Accordingly, the first baked good 552 and the second baked good 554 can be operatively coupled via the tab 504. In some embodiments, each distinct filing element can be placed in a distinct non-connected compartment. For example, the one or more protein items 556 can be placed within the third distinct compartment 508 and the one or more produce items can be placed withing the fourth distinct compartment 510. In the marketable configuration, the non-connected compartments can be placed between the connected compartments. For example, the third distinct compartment 508 can be placed on top of the first distinct compartment 502, the fourth distinct compartment 510 can be placed on top of the third distinct compartment 508, and the second distinct compartment 506 can be placed on top of the fourth distinct compartment 510. As shown in FIGS. 5A-5B, the length of the tab 504 can be at least as long as half of the thickness of the first baked good 552, the entire thickness of the filling (e.g., the entire thickness of the one or more protein items 556 and the entire thickness of the one or more produce items 558), and half the thickness of the second baked good 554.

The following may describe a non-limiting example of a packaging consistent with this disclosure. The packaging may be configured to provide a first baked good 552, a second baked good 554, a protein item 556, and a dairy item. The first baked good 552 and the second baked good 554 may be individually stored within compartments connected by a tab 504. The tab 504 can be arranged along the contact surfaces of the first compartment and the second compartment. In some embodiments, the tab 504 can have a length of 1 inch, or about 1 inch. The protein item 556 and the dairy item may be individually stored within non-connected compartments. For example, as shown in FIG. 5A. In some embodiments, the first baked good 552 can be a bottom bun. For example, the first baked good 552 can be circular or substantially circular having a diameter of 4 inches, or about 4 inches. The first baked good 552 can have a thickness of ½ inch or about ½ inch. In some embodiments, the thickness of the first baked good 552 can be uniform. In some embodiments, the thickness of the first baked good 552 can taper from the center to the radial edge. For example, the first baked good 552 can have a maximum thickness at the center and can radially taper to a minimum thickness at the radial edge. In some embodiments, the second baked good 554 can be the same or substantially similar to the first baked good 552. For example, the second baked good 554 can be a top bun. The second baked good 554 can be circular or substantially circular. In some embodiments, the second baked good can have a different size. For example, the second baked good can have a diameter of 4¼ inches, or about 4¼ inches. The second baked good 554 can have a thickness of ½ inch, or about ½ inch. The thickness of the second baked good 554 can be uniform. In some embodiment's the thickness of the second baked good 554 can taper from the center to a radially outward edge. For example, the second baked good 554 can have a maximum thickness at the center and can radially taper to a minimum thickness at a radial edge. In some embodiments, the protein item 556 can be a hamburger patty. For example, the protein item 556 can be a circular protein item having a diameter of 4½ inches, or about 4½ inches. In some embodiments, the protein item may have a non-uniform radial edge. The protein item 556 can have a thickness of ½ inch, or about ½ inch. The dairy item can be a pre-sliced cheese. The dairy item can have a rectangular shape. In some embodiments, the dairy item can have a length of 3¼ inches, or about 3¼ inches and a width of 3¼ inches, or about 3¼ inches. The dairy item can have a thickness of 1/16 inch, or about 1/16 inch. In the marketable configuration, the first baked good 552 can form a first layer, the protein item 556 can be positioned above the first baked good 552 forming a second layer, the dairy item can be positioned above the protein item 556 forming a third layer, and the second baked good 554 can be positioned above the dairy item forming a fourth layer. In the marketable configuration, the distinct ingredients can be arranged to represent an assembled hamburger sandwich. As described above, the tab 504 can have a length of 1 inch, or about 1 inch. Accordingly, the tab 504 can account for the thickness of the protein item 556 (½ inch, or about ½ inch) and the thickness of the dairy item ( 1/16 inch, or about 1/16 inch.). Since the tab 504 extends from the contact surfaces of the first and second compartments, the nominal length of the tab 504 can be 7/16 inch, or about 7/16 inch.

The following may describe another non-limiting example of a packaging consistent with this disclosure. The packaging may be configured to provide a first baked good 552, a second baked good 554 and a protein item 556. The first baked good 552 and the second baked good 554 may be individually stored within compartments connected by a tab 504. The tab 504 can be arranged along the midpoint of the first compartment and the second compartment. In some embodiments, the tab 504 can have a length of 1¾ inch, or about 1¾ inch. The protein item 556 may be individually stored within a non-connected compartment, for example, as shown in FIG. 5A. In some embodiments, the first baked good 552 can be a bottom half of a biscuit. The first baked good 552 can be circular or substantially circular having a diameter of 3½ inches, or about 3½ inches. The first baked good 552 can have a thickness of ½ inch or about ½ inch. In some embodiments, the thickness of the first baked good 552 can be uniform. In some embodiments, the second baked good 554 can be the same or substantially similar to the first baked good 552. For example, the second baked good 554 can be a top half of a biscuit. The second baked good 554 can be circular or substantially circular. In some embodiments, the second baked good can have the same size. For example, the second baked good can have a diameter of 3½ inches, or about 3½ inches. The second baked good 554 can have a thickness of ½ inch, or about ½ inch. The thickness of the second baked good 554 can be uniform. In some embodiments, the protein item 556 can be a sausage patty. For example, the protein item 556 can be a circular protein item having a diameter of 3½ inches, or about 3½ inches. In some embodiments, the protein item may have a non-uniform radial edge. The protein item 556 can have a thickness of ¼ inch, or about ¼ inch. In the marketable configuration, the first baked good 552 can form a first layer, the protein item 556 can be positioned above the first baked good 552 forming a second layer, and the second baked good 554 can be positioned above the protein item forming a third layer. In the marketable configuration, the distinct ingredients can be arranged to represent an assembled sausage sandwich. In some embodiments, the compartments can be glued together. Accordingly, the packaging can be secured within the marketable configuration. As described above, the tab 504 can have a length of 1¾ inch, or about 1¾ inch. Accordingly, the tab 504 can account for the thickness of the protein item 556 (¼ inch, or about ¼ inch), half the thickness of the first baked good 552 (¼ inch, or about ¼ inch), and half the thickness of the second baked good 554 (¼ inch, or about ¼ inch). Since the tab 504 extends from the midpoint of the first and second compartments, the nominal length of the tab 504 can be ¾ inch, or about ¾ inch. The additional nominal length can provide additional slack in the packaging.

FIGS. 5C-5D illustrate a second embodiment of a packaging 500B of a product 550B wherein none of the compartments are connected. For example, in some embodiments, all of the compartments are independent of the other compartments.

As shown in FIGS. 5C-5D, the packaging 500A can include a plurality of non-connected compartments. For example, the packaging 500B can include a first distinct compartment 502, a second distinct compartment 506, a third distinct compartment 508 and a fourth distinct compartment 510. In some embodiments, additional or fewer non-connected compartments may be included. The product 550B can be the same or similar to the product 550A described above.

The plurality of non-connected compartment can be arranged in any order since tabs do not connect two compartments together. In some embodiments, the first baked good 552 can be placed within the first distinct compartment 502 and the second baked good 554 can be placed within the second distinct compartment 506. The one or more protein items 556 can be placed within the third distinct compartment 508 and the one or more produce items can be placed withing the fourth distinct compartment 510. In the marketable configuration, the third distinct compartment 508 can be placed on top of the first distinct compartment 502, the fourth distinct compartment 510 can be placed on top of the third distinct compartment 508, and the second distinct compartment 506 can be placed on top of the fourth distinct compartment 510. In some embodiments, the one or more protein items 556 can form a base, the one or more produce items 558 can be placed on top of the one or more protein items 556, the first baked good 552 can be placed on top of the one or more produce items 558, and the second baked good 554 can be placed on top of the first baked good 552.

FIGS. 5E-5F illustrate a third embodiment of a packaging 500C of a product 550C wherein all of the compartments are connected. For example, each compartment is attached to the next compartment via a tab.

As shown in FIGS. 5E-5F, the packaging 500C can include a plurality of connected compartments. For example, the packaging 500C can include a first distinct compartment 502, a second distinct compartment 506, a third distinct compartment 508 and a fourth distinct compartment 510. The packaging 500C can further include the tab 504 (e.g., a first tab), a second tab 513, and a third tab 514. The tab 504 can extend between the first distinct compartment 502 and the second distinct compartment 506. The second tab 513 can extend between the second distinct compartment 506 and the third distinct compartment 508. The third tab 514 can extend between the third distinct compartment 508 and the fourth distinct compartment 510. As shown in FIG. 5F, the packaging 500C can be Z-folded or accordion folded as described above. In some embodiments, additional or fewer compartments may be included.

Each of the tabs have a length. For example, the first tab 504 can have a first length L1, the second tab 513 can have a second length L2, and the third tab 514 can have a third length L3. In some embodiments, the lengths of the tabs can depend on one or more of the following factors: (1) the position of the tabs relative to the adjacent distinct compartments (e.g., along an edge, along the midline, or along another position of the thickness of the packaging); (2) the thickness of the adjacent distinct compartments and/or the thickness of the ingredients to be contained within the adjacent distinct compartments; (3) whether the adjacent distinct compartments have a deformable section; and (4) whether one or more distinct compartments are placed between the adjacent distinct compartments. The length L1 of the first tab 504 can the distance between the tab height of the first tab 504 and the contact surface of the first distinct compartment 502, the distance between the tab height of the first tab 504 and the contact surface of the second distinct compartment 506, and a nominal length (e.g., a constant predetermined value or a predetermined percentage of the summed length of the distance between the tab height of the first tab 504 and the contact surface of the first distinct compartment 502 and the distance between the tab height of the first tab 504 and the contact surface of the second distinct compartment 506). In some examples, the tab length L1 can also include the thickness of ingredients configured to be placed between the first distinct compartment 502 and the second distinct compartment 506. The length L2 of the second tab 513 can the distance between the tab height of the second tab 513 and the contact surface of the second distinct compartment 506, the distance between the tab height of the second tab 513 and the contact surface of the third distinct compartment 508, and a nominal length (e.g., a constant predetermined value or a predetermined percentage of the summed length of the distance between the tab height of the second tab 513 and the contact surface of the second distinct compartment 506 and the distance between the tab height of the second tab 513 and the contact surface of the third distinct compartment 508). In some examples, the tab length L2 can also include the thickness of ingredients configured to be placed between the second distinct compartment 506 and the third distinct compartment 508. The length L3 of the third tab 514 can the distance between the tab height of the third tab 514 and the contact surface of the third distinct compartment 508, the distance between the tab height of the third tab 514 and the contact surface of the fourth distinct compartment 510, and a nominal length (e.g., a constant predetermined value or a predetermined percentage of the summed length of the distance between the tab height of the third tab 514 and the contact surface of the third distinct compartment 508 and the distance between the tab height of the third tab 514 and the contact surface of the fourth distinct compartment 510). In some examples, the tab length L3 can also include the thickness of ingredients configured to be placed between the third distinct compartment 508 and the fourth distinct compartment 510. The product 550C can be the same or similar to the product 550A described above.

The first baked good 552 can be placed within the first distinct compartment 502, the one or more protein items 556 can be placed within the second distinct compartment 506, the one or more produce items can be placed within the third distinct compartment 508, and the second baked good 554 can be placed within the fourth distinct compartment 510. In the marketable configuration, the second distinct compartment 506 can be placed on top of the first distinct compartment 502, the third distinct compartment 508 can be placed on top of the second distinct compartment 506, and the fourth distinct compartment 510 can be placed on top of the third distinct compartment 508. In some embodiments, additional or fewer compartments may be included.

In some embodiments, the tab 504 has a length L1 at least as long as the thickness of the one or more protein items 556. In some embodiments, the second tab 513 has a length L2 at least as long as the thickness of the one or more protein items 556 and the thickness of the one or more produce items 558. In some embodiments, the third tab 514 has a length L3 at least as long as the thickness of the one or more produce items 558. As shown in FIG. 5F, the packaging 500C can be folded according to an accordion fold into the marketable configuration.

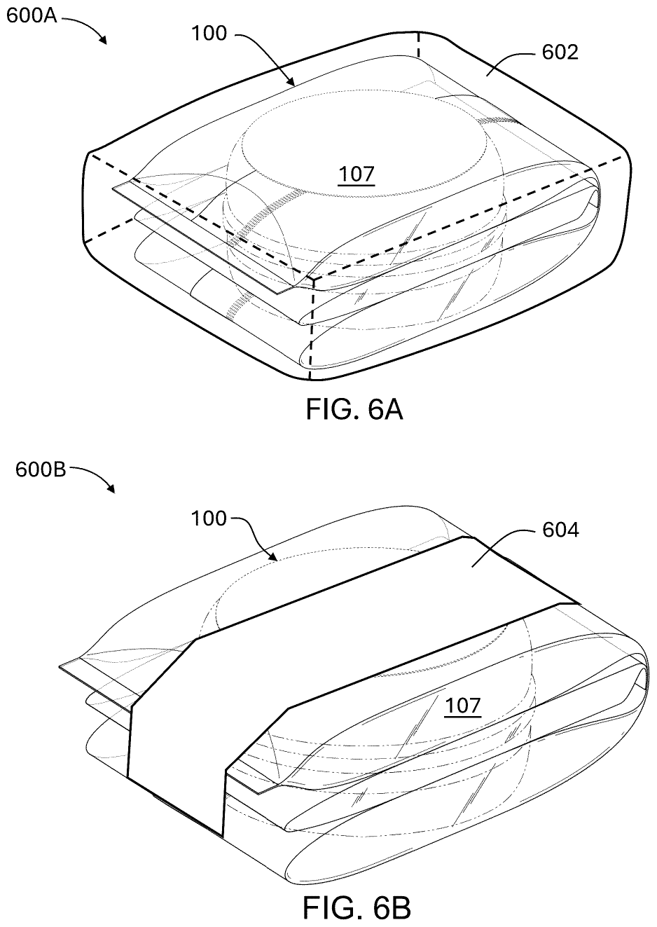

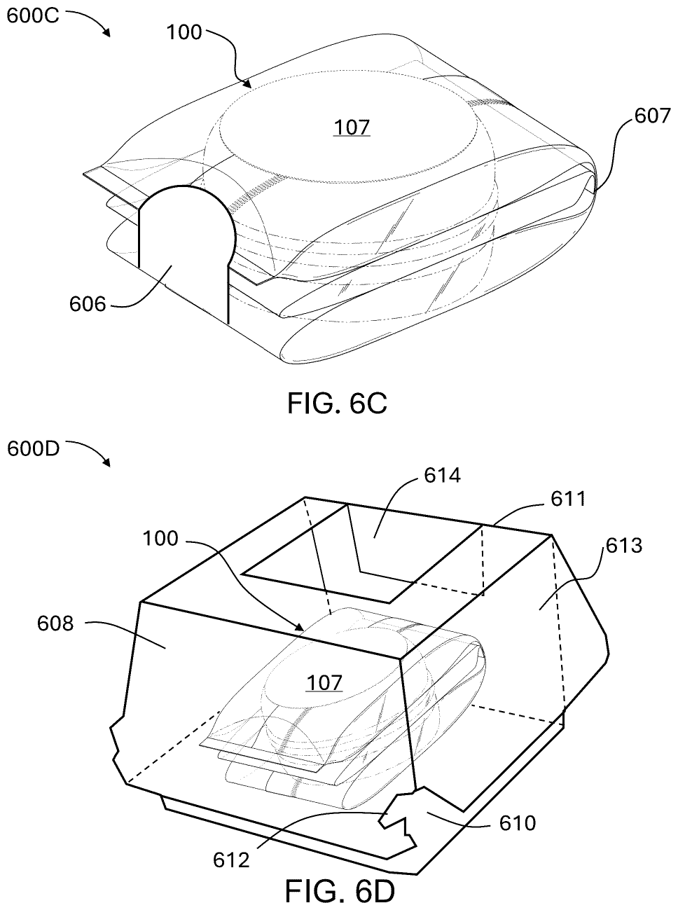

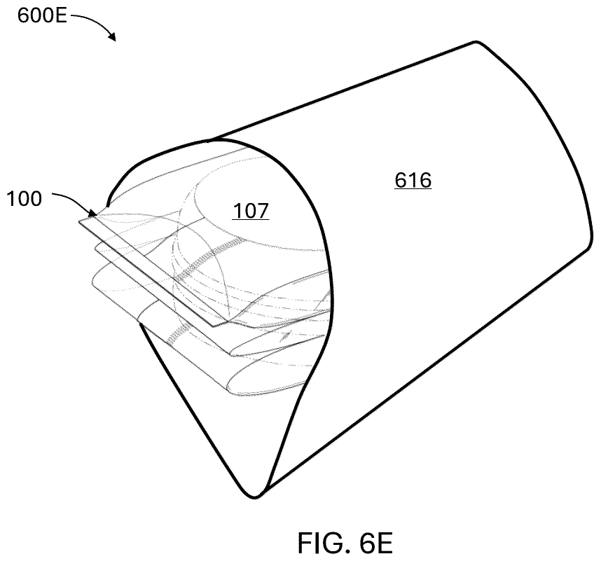

FIGS. 6A-6E illustrate examples of an overwrap for securing the product 107 in the marketable configuration 100.

FIG. 6A is a perspective view of the marketable configuration 100 of a product 107, as described in any of the embodiments above, in a plastic overwrap 602. The plastic overwrap 602 can extend around the marketable configuration 100 and prevent the packaging from unraveling. For example, the marketable configuration 100 can be surrounded on all sides by the plastic overwrap 602. Accordingly, the product 107 can remain in the marketable configuration 100 during shipping and storage of the product 107. In some embodiments, the overwrap may be flow wrapped, welded or thermoformed, bagging, vertical forming, vertical filling, and/or vertical sealing.

FIG. 6B is a perspective view of the marketable configuration 100 of a product 107, as described in any of the embodiments above, in a band overwrap 604. The band overwrap 604 can extend around a portion of the marketable configuration 100 and prevent the packaging from unraveling. For example, the marketable configuration 100 can be surrounded on four sides by the band overwrap 604. In some embodiments, the overwrap may be adhered together, and/or mechanically wrapped around the marketable configuration 100 and secured via an ultrasound weld.

FIG. 6C is a perspective view of the marketable configuration 100 of a product 107, as described in any of the embodiments above, secured together by an adhesive sticker 606. The adhesive sticker 606 can extend from the uppermost compartment of the marketable configuration 100 to the lowermost compartment of the marketable configuration 100 thereby securing the packaging in the marketable configuration 100. In some embodiments, the adhesive sticker 606 is positioned on a side of the packaging opposite the one or more tabs 607. The one or more tabs 607 can be the same or similar to the tabs described above. In some embodiments, the one or more tabs 607 can extend between the uppermost compartment to the lowermost compartment. In some embodiments, the overwrap may be adhered directly onto the inner packaging.

FIG. 6D is a perspective view of the marketable configuration 100 of a product 107, as described in any of the embodiments above, in a clamshell box 608. In some embodiments, the clamshell box 608 can be a sandwich box. The clamshell box 608 can further include a first portion 609 and a second portion 610. The first portion 609 can be hingedly connected to the second portion 610 via a hinge 611 connecting the first portion 609 and the second portion 610. The hinge 611 can be a fold in the clamshell box 608. The first portion 609 and the second portion 610 can be secured together by engagement features 612 positioned on a side of the clamshell box 608 opposite the hinge 611. For example, the clamshell box 608 can be the same or similar to the container 220 described in U.S. Pat. No. 10,183,458 entitled “Insulated Packaging and Method of Making Same” filed Jul. 28, 2017. In a closed state, the clamshell box 608 can maintain the product in the marketable configuration 100. In some embodiments, the clamshell box 608 can further include a transparent section 614. The transparent section 614 can extend along at least a portion of the first portion 609 and a rear wall 613 of the clamshell box 608. In some embodiments, the transparent section 614 can extend along the hinge 611 as shown in FIG. 6D. The transparent section 614 can allow a consumer to see the marketable configuration 100 without opening the clamshell box 608. The clamshell box 608 can advantageously provide for improved stacking and for the addition of smaller components or ingredients (e.g., condiment packets) and enhancing detection of product tampering.

FIG. 6E is a perspective view of the marketable configuration 100 of a product 107, as described in any of the embodiments above, in a semi-open container 616. The semi-open container 616 can include one or more bottom walls and one or more side walls extending from the one or more bottom walls. For example, the semi-open container 616 can be a hollow truncated cone having an open end and a closed end. The semi-open container 616 can be the same or similar to the carton 270 described in U.S. Pat. No. 10,183,458 entitled “Insulated Packaging and Method of Making Same” filed Jul. 28, 2017. In some embodiments, the one or more side walls may be adjoined to form one side wall. In some embodiments, the semi-open container 616 can be formed from or suing one or more blanks. In an assembled state, the semi-open container 616 can form a cavity or recessed area between the one or more side walls and the one or more bottom walls. In such embodiments, the marketable configuration 100 can be placed withing cavity or recessed area.

In the present description, numerous specific details are set forth in order to provide a thorough understanding of the present disclosure for the purposes of explanation. It will be apparent, however, that the embodiments described by the present disclosure can be practiced without these specific details. Specific arrangements or orderings are illustrated in the drawings for ease of description. However, it will be understood by those skilled in the art that the specific ordering or arrangement of the elements in the drawings is not meant to imply that a particular order is required unless explicitly described as such.

Although the terms first, second, third, and/or the like are used to describe various elements, these elements should not be limited by these terms. The terms first, second, third, and/or the like are used only to distinguish one element from another. For example, a first ingredient could be termed a second ingredient and, similarly, a second ingredient could be termed a first ingredient without departing from the scope of the described embodiments. The first ingredient and the second ingredient are both food items, but they are not the same ingredient.

The terminology used in the description of the various described embodiments herein is included for the purpose of describing particular embodiments only and is not intended to be limiting. As used in the description and the various described embodiments and the appended claims, the singular forms “a,” “an,” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

In the preceding detailed description, numerous specific details are set forth in order to provide a thorough understanding of the various described embodiments. However, it will be apparent to one of ordinary skill in the art that the various described embodiments can be practiced without these specific details.

What is claimed is:

1. A packaged food item comprising:
an inner packaging comprising a plurality of compartments arranged in a marketable configuration;
a plurality of distinct ingredients, each of the plurality of distinct ingredients positioned within a distinct one of the plurality of compartments; and
an overwrap positioned around the inner packaging;
wherein:
the plurality of distinct ingredients are subcomponents of a single food product;
the marketable configuration visually presents the plurality of distinct ingredients as the single food product; and
the overwrap maintains the inner packaging in the marketable configuration.

2. The packaged food item of claim 1, wherein at least two of the plurality of distinct ingredients are different.

3. The packaged food item of claim 1, wherein the single food product is a sandwich.

4. The packaged food item of claim 1, wherein each of the plurality of distinct ingredients are at least one of a baked good, a protein item, a produce item, or a dairy item.

5. The packaged food item of claim 4, wherein a protein item is positioned between a first baked good and a second baked good in the marketable configuration.

6. The packaged food item of claim 5, wherein the plurality of compartments are stacked in the marketable configuration.

7. The packaged food item of claim 1, further comprising one or more tabs each extending between two adjacent compartments of the plurality of compartments, wherein the one or more tabs comprise a length, wherein the length of each of the one or more tabs follows the following relationship L=Y1+Y2+C+F, wherein L is the length of the tab, Y1 is a distance between a tab height of the tab and a contact surface of a first compartment of the two adjacent compartments, Y2 is a distance between the tab height and a contact surface of a second compartment of the two adjacent compartments, C is a nominal length, and F is a thickness of a filling positioned between the two adjacent compartments.

8. The packaged food item of claim 1, further comprising one or more tabs each extending between two adjacent compartments of the plurality of compartments, wherein each of the one or more tabs comprise a length, wherein the length of each of the one or more tabs is based on the position of the tab relative to the adjacent distinct compartments, the thickness of the ingredients to be contained within the adjacent distinct compartments, and whether one or more distinct ingredients are placed between the adjacent distinct compartments in the marketable configuration.

9. A packaging system for packaging a marketable product, the packaging system comprising:
a plurality of compartments having a corresponding thickness; and
an overwrap configured to secure the plurality of compartments in a marketable configuration;
wherein:
each of the plurality of compartments is configured to receive a distinct component of the marketable product; and
the marketable configuration visually presents the distinct components as the marketable product.

10. The packaging system of claim 9, further comprising one or more tabs each extending between two adjacent compartments of the plurality of compartments, wherein each of the one or more tabs comprise a length, wherein the length of each of the one or more tabs follows the following relationship L=Y1+Y2+C+F, wherein L is the length of the tab, Y1 is a distance between a tab height of the tab and a contact surface of a first compartment of the two adjacent compartments, Y2 is a distance between the tab height and a contact surface of a second compartment of the two adjacent compartments, C is a nominal length, and F is a thickness of a filling positioned between the two adjacent compartments.

11. The packaging system of claim 9, further comprising one or more tabs each extending between two adjacent compartments of the plurality of compartments, wherein each of the one or more tabs comprise a length, wherein the length of each of the one or more tabs is based on the position of the tab relative to the adjacent distinct compartments, the thickness of the adjacent distinct compartments, and whether one or more distinct compartments are placed between the adjacent distinct compartments in the marketable configuration.

12. A packaging system for packaging a marketable product, the packaging system comprising:
a plurality of compartments, each of the plurality of compartments comprising a thickness and a contact surface positioned at an end of the thickness;
a plurality of tabs each extending between two adjacent compartments of the plurality of compartments;
wherein:
the plurality of compartments are configured to receive a distinct component of the marketable product;
each of the plurality of tabs have a length corresponding to the sum of a distance between the tab and the contact surface of a first compartment of the two adjacent compartments, a distance between the tab and the contact surface of a second compartment of the two adjacent compartments, a nominal length, and a distance corresponding to thickness of a filling to be placed between the two adjacent compartments; and
the packaging system is configured to be positioned in a marketable configuration visually presenting the distinct components as the marketable product.

13. The packaging system of claim 12, further comprising an overwrap positioned at least partially around the plurality of compartments in the marketable configuration.

14. The packaging system of claim 12, wherein the marketable product is a sandwich.

15. The packaging system of claim 14, wherein the plurality of compartments comprises a first compartment, a second compartment, and a third compartment; wherein the first compartment comprises a first thickness corresponding to a thickness of a first baked good, the second compartment comprising a second thickness corresponding to a thickness of a protein item, and the third compartment comprises a third compartment corresponding to a thickness of a second baked good.

16. The packaging system of claim 12, wherein the packaging system is made of plastic.

17. The packaging system of claim 13, wherein the overwrap is a clamshell box comprising a first portion, a second portion, a hinge connecting the first portion and the second portion, the clamshell box further comprising a transparent section positioned at least partially along the first portion and a rear wall of the clamshell box.

18. The packaging system of claim 13, wherein the overwrap is a hollow truncated cone having an open end and a closed end.

19. The packaging system of claim 13, wherein the overwrap is a band.

20. The packaging system of claim 12, wherein the marketable configuration is achieved by accordion folding the packaging system about the plurality of tabs.
